(19) United States
(12) Patent Application Publication
(10) Pub. No.: US 2026/0354299 A1
(43) Pub. Date: Nov. 12, 2026

(54) METHOD OF SUSTAINABLE REFORESTATION

(71) Applicant: VIRIDIS ARBOR LLC, Verona, NJ (US)

(72) Inventor: Gary E. Abeles, Verona, NJ (US)

(73) Assignee: VIRIDIS ARBOR LLC, Verona, NJ (US)

(21) Appl. No.: 19/736,381

(22) Filed: Jul. 9, 2026

Related U.S. Application Data
(63) Continuation-in-part of application No. 19/531,012, filed on Feb. 5, 2026, now Pat. No. 12,714,005.
Application No. 19/531,012 is a continuation-in-part of application No. 19/222,317, filed on May 29, 2025, now Pat. No. 12,568,893.
Application No. 19/222,317 is a continuation-in-part of application No. 18/700,343, filed on Sep. 1, 2022, now Pat. No. 12,787,947.
(63) Continuation-in-part of application No. 18/700,343, filed on Sep. 1, 2022, now Pat. No. 12,787,947.
(60) Provisional application No. 63/272,960, filed on Oct. 28, 2021.

(51) Int. Cl. A01C 7/08; A01C 14/00; A01G 9/029; B64D 1/02; B64U 20/80; B64U 101/40

(52) U.S. Cl. CPC A01C 7/085; A01C 14/00; A01G 9/0291; B64D 1/02; B64U 20/80; B64U 2101/40

(57) ABSTRACT

A reforestation method includes selecting a species or variety of trees to be planted in a reforestation region, selecting a sustainability period for a replacement forest, estimating an available water supply, and determining an expected water requirement for each of the trees at an end of the sustainability period. A minimum average tree separation is determined according to the available water supply, the water requirement, and the sustainability period. Seed planting devices containing seeds, seedlings, and/or saplings of the selected species or variety are deployed at deployment locations having an average separation that is at least as large as the minimum average separation. Each seed planting device includes a tapered container or shell that penetrates into the forest floor. The seed planting devices can penetrate a hydrophobic layer, if present, so that the roots of the trees can grow and extend beneath the hydrophobic layer.

### RELATED APPLICATIONS

This application is a continuation in part of U.S. Application No. 19/531,012, filed on Feb. 5, 2026. Application 19/531,012 is a continuation in part of U.S. Application No. 19/222,317, filed on May 29, 2025, now U.S. patent 12,568,893. Application 19/222,317 is a continuation in part of U.S. Application No. 18/700,343, filed on Apr. 11, 2024. Application 18/700,343 is a national phase application filed under 35 USC §371 of PCT Application No. PCT/US2022/42322 with an international filing date of Sep. 1, 2022. PCT Application PCT/US2022/42322 claims the benefit of U.S. Provisional Application No. 63/272,960, filed Oct. 28, 2021. This application is also a continuation in part of U.S. Application No. 18/700,343. All of these applications are incorporated herein by reference in their entirety for all purposes.

### FIELD OF THE INVENTION

The invention relates to restoration of forests after damage due to fire, drought, disease, insect infestation, logging, or other causes, and more particularly, sustainable reforestation by aerial deployment of seed planting devices.

### BACKGROUND OF THE INVENTION

Ecological recovery after a forest fire has always been a challenge, especially in heavily vegetated areas that are unpopulated, or only sparsely populated. Furthermore, recent trends in global climate change have resulted in consistently higher temperatures and persistent droughts in many areas, which in turn have increased the risks and the occurrences of major fires in wilderness and other sparsely populated areas. In addition, forests can be damaged by drought, disease, insect infestation, logging, and other causes.

With reference to FIG. 1, during intense forest fires, a waxy substance derived from the burning plant material is formed. Initially created as a gas, this substance penetrates into the topsoil and then hardens, creating what is called a “hydrophobic layer” 102 above the underlying layer of normal soil 104. This hydrophobic layer 102 prevents rainwater from sinking into the ground and reaching the underlying soil 104 that would otherwise be able to absorb the water. A thin layer of ash 100 may be formed on top of the hydrophobic layer 102, but is insufficient to absorb rain water falling onto a mountain or other sloping surface after a forest fire, so that the rainwater has no choice but to flow downhill primarily on top of the hydrophobic layer 102, carrying with it the layer of ash 100 and any debris that it may encounter, as well as any normal soil that it flows over. The result is what is commonly referred to as a mudslide.

Often, in the aftermath of a forest fire, an effort is made to stabilize the soil 104 by introducing new vegetation 106 into the area, typically by dropping seeds onto the burned-over ground that will hopefully take root and reduce the likelihood and/or severity of mudslides. However, the roots of the new vegetation 106 have difficulty penetrating through the hard hydrophobic layer 102, which means that, typically, the roots will be mainly on the surface of the ground above the hydrophobic layer 102. The new vegetation 106 will therefore be poorly anchored to the ground, and easily carried away with flowing rainwater, becoming part of a mudslide.

In some applications, however, successful reforestation requires more than simply causing seeds, seedlings, or saplings to reach the forest floor and germinate or grow. In particular, randomly scattering seeds or planting seeds, seedlings, and/or saplings too close to each other can produce an initially healthy plurality of young trees that later becomes unsustainable. As the newly planted replacement trees grow, their diameters and water requirements may initially be relatively small, but both may increase substantially as the trees mature. Accordingly, a group of trees that do not unduly overlap with each other and can be supported by available water resources when the trees are small may become too large and dense to remain healthy after the trees have grown for several years.

The long-term sustainability of a reforested area can depend, among other things, on the species or variety of tree that is planted, the expected water requirement of the selected tree species or variety at different stages of maturity, the water table and/or aquifer capacity, expected rainfall, soil characteristics, slope, runoff, and other sources or limitations of available water. An average separation between the trees that is sustainable for a short period may not be sustainable over a longer period during which the trees mature, expand in size, and require increased amounts of water.

It should be noted that, for ease of expression, the term “forest” is used herein to refer to an area in which trees are, or are intended to become, a dominant form of vegetation, whether or not the area is a wilderness area, an otherwise unpopulated area, or a sparsely populated area. The term “forest fire” is used generically herein to refer to any fire that takes place in such a forest. The term “reforestation” is used herein to refer to planting or replanting of trees in an area that has been damaged by fire, drought, disease, insect infestation, logging, blight, storm damage, or any other cause. The terms “tree seeds,” “tree seedlings,” and “tree saplings” are used herein to refer, respectively, to seeds, seedlings, and saplings of trees, unless otherwise required by context.

What is needed, therefore, is a method of reforesting a reforestation region such that the replacement trees will grow and thrive during the entirety of a sustainability period without undue crowding, and without exceeding an available water supply in the reforestation region.

### SUMMARY OF THE INVENTION

The present invention is a method of establishing replacement trees in a reforestation region such that the replacement trees will grow and thrive during the entirety of a sustainability period without undue crowding, and without exceeding an available water supply in the reforestation region.

According to the present invention, a minimum average separation of the replacement trees in the reforestation region is determined according to the length of the sustainability period, the available water supply, and an anticipated water requirement of each replacement tree of the selected tree species or variety at the end of the sustainability period. Seed planting devices containing seeds, seedlings, or saplings of the selected species or variety are then deployed in the reforestation region in deployment locations having an average separation that is equal to or greater than the determined minimum average separation.

In the seed planting devices, the seeds, seedlings, or saplings can be mixed together with soil, sand, gravel, water, fertilizer, super-absorbent polymer granules, and/or other support materials. The term “seed mixture” is used herein generically to refer to the seeds, seedlings, and/or saplings, whether or not they are mixed with other materials. The seed planting devices are tapered seed planting devices which, in embodiments, are configured to penetrate through a hydrophobic layer, if present.

In embodiments, the available water supply is determined according to one or more water availability parameters, which can include, for example, a water table depth, an aquifer capacity, expected rainfall, historical rainfall, expected drought frequency, soil type and water retention, slope, runoff, drainage, watershed characteristics, irrigation availability, and/or other sources or limitations of water available to the replacement trees.

Determining the minimum average separation of the replacement trees also includes determining a water requirement of each tree of the selected tree species or variety, which will increase as each tree matures and grows. Selecting the tree species or variety can include performing a genetic analysis of tree species and/or varieties and considering the water requirements, growth rates, and resistance to climate change of each species or variety.

In embodiments, the seed planting devices are deployed in the selected deployment locations by one or more unmanned aerial vehicles (UAVs), which are sometimes referred to herein as “drones.” Because it is desirable that the deployment locations avoid rocks, burned stumps, fallen trees, terrain slope, and any other local obstacles, the seed planting devices need not be deployed in a strict geometric array. In embodiments, the drones can use surface-sensing data to locally adjust deployment locations to avoid such obstacles, while maintaining at least the determined minimum average separation.

The one or more drones can be controlled according to the deployment locations so as to drop, release, propel, press, or otherwise deposit the seed planting devices onto or into the forest floor. The drones can use GPS navigation, inertial navigation, optical navigation, terrain mapping, wind speed data, wind direction data, altitude data, release timing, and/or other navigation or compensation data to place the seed planting devices at the deployment locations.

In embodiments, the one or more drones include a seed planting device release mechanism, and a controller configured to cause the seed planting devices to be released at the deployment locations. In embodiments, the seed planting devices are used in a reforestation region that has been damaged by fire, drought, disease, insect infestation, logging, blight, storm damage, or another cause.

Each of the seed planting devices comprises a tapered container or tapered shell having a top, a bottom, and an outer tapered surface extending therebetween. A horizontal cross-sectional area of the tapered container or tapered shell is larger proximate the top than proximate the bottom, and the outer tapered surface decreases in horizontal size from the top toward the bottom, so that the seed planting device is configured to penetrate into the forest floor when deployed. In embodiments, the decrease in horizontal size is linear along at least a portion of a vertical length of the seed planting device. In embodiments, the tapered container or tapered shell is round, oval, polygonal, star-shaped, irregular, symmetric, asymmetric, or any other cross-sectional shape, provided that the seed planting device tapers toward the bottom.

Before the seed planting device is deployed, no part of the seed planting device, including the one or more seeds, seedlings, and/or saplings, extends vertically or radially beyond the outer tapered surface of the tapered container or tapered shell. In embodiments, the seed planting device is configured, when deployed, to penetrate into the forest floor and to enable the one or more seeds, seedlings, and/or saplings contained within the tapered container or tapered shell to germinate and grow out from the seed planting device. In some embodiments, the seed planting device is configured to penetrate through a hydrophobic layer of a forest floor in a reforestation region that has experienced a forest fire, thereby enabling water and roots to reach soil beneath the hydrophobic layer.

In embodiments, at least one hole is provided proximate the bottom of the tapered container or tapered shell. In embodiments, the at least one hole penetrates the outer tapered surface proximate the bottom. The at least one hole enables water to seep and roots to emerge, while being small enough to prevent significant loss of seeds, seedlings, saplings, and/or support materials before deployment. In some embodiments, the seed planting device includes a weighted and/or pointed tip that provides additional weight, energy, and penetrating power. In embodiments, the weighted and/or pointed tip is configured to be separated from the tapered container or tapered shell by roots growing downward from new vegetation arising from the seeds, seedlings, and/or saplings after deployment of the seed planting device, thereby creating an opening in the bottom of the tapered container or tapered shell.

In embodiments, each of the seed planting devices includes a perforated or porous lid fixed within the tapered container or tapered shell above the contained seeds, seedlings, saplings, and/or support materials. The openings in the lid can be small enough to prevent significant ejection of the contained materials during deployment, while being large enough to allow rainwater to enter the seed planting device and/or to allow new vegetation to pass through the lid as it grows.

In embodiments, the seed planting devices, lids, tips, and/or other components thereof are made from one or more biodegradable materials, so that after the seed planting devices have been deployed and the trees have become established, the seed planting devices biodegrade and blend into the soil.

The present invention is a method of reforesting a reforestation region. The method includes selecting a species or variety of replacement trees to be planted in the reforestation region, selecting a sustainability period for a replacement forest to be established in the reforestation region, estimating an available water supply for the reforestation region during the sustainability period, determining a water requirement of replacement trees of the selected species or variety at an end of the sustainability period, based on an assumption that the replacement trees remain healthy and continue to grow throughout the sustainability period, and according to the available water supply, the water requirement, and the sustainability period, determining a minimum average separation of the replacement trees that will enable the replacement trees to remain healthy at the end of the sustainability period without undue crowding and without exceeding the available water supply.

The method further includes providing a plurality of seed planting devices, each of the seed planting devices comprising a tapered container or tapered shell having a top, a bottom, and an outer tapered surface extending between the top and the bottom, wherein a horizontal cross-sectional area of the tapered container or tapered shell is larger proximate the top than proximate the bottom, and said horizontal cross-sectional area decreases monotonically from the top to the bottom, at least one hole penetrating the outer tapered surface proximate the bottom, and one or more seeds, seedlings, and/or saplings of the selected species or variety contained within the tapered container or tapered shell, wherein, before the seed planting device is deployed, no part of the seed planting device, including the one or more seeds, seedlings, and/or saplings, extends vertically or radially beyond the outer tapered surface of the tapered container or tapered shell.

The method also includes determining deployment locations in the reforestation region, wherein an average separation of the deployment locations is equal to or greater than the determined minimum average separation, and deploying the seed planting devices at the deployment locations, such that the seed planting devices penetrate into a forest floor of the reforestation region and the seeds, seedlings, and/or saplings germinate and/or grow into replacement trees.

In embodiments, deploying the seed planting devices comprises deploying the seed planting devices using one or more drones. In some of these embodiments the one or more drones deploy the seed planting devices by dropping, releasing, propelling, pressing, or otherwise depositing the seed planting devices onto or into the forest floor. In any of these embodiments, the one or more drones can comprise one or more surface sensors configured to detect surface features of the reforestation region, and the one or more drones can use surface-sensing data from the one or more surface sensors to avoid tree stumps, rocks, fallen trees, standing dead trees, bodies of water, steep terrain features, debris, and/or other obstacles or unsuitable surface locations. In some of these embodiments, the one or more surface sensors comprise one or more visible-light cameras, infrared cameras, thermal cameras, LIDAR sensors, stereo-vision sensors, structured-light sensors, radar range sensors, ultrasonic range sensors, multispectral cameras, and/or hyperspectral cameras.

In any of the above embodiments, selecting the species or variety of replacement trees to be planted in the reforestation region can include performing a genetic analysis of tree species and/or varieties and considering water requirements, growth rates, and resistance to climate change of each considered species or variety.

In any of the above embodiments, estimating the available water supply can include determining at least one water availability parameter selected from the group consisting of water table depth, aquifer capacity, expected rainfall, historical rainfall, expected drought frequency, soil type, soil water retention, slope, runoff, drainage, watershed characteristics, and irrigation availability.

In any of the above embodiments, determining the water requirement can include determining a water requirement of the selected species or variety according to tree age, maturity, size, canopy spread, root development, season, climate, and/or expected growth rate.

In any of the above embodiments, the sustainability period can be at least 100 years.

In any of the above embodiments, the reforestation region can be a region that has been damaged by fire. In some of these embodiments, the reforestation region includes a hydrophobic layer beneath a layer of ash, and deploying the seed planting devices causes the seed planting devices to penetrate through the hydrophobic layer.

In any of the above embodiments, a horizontal cross-sectional shape of the tapered container or tapered shell can be round, oval, square, polygonal, or star-shaped.

In any of the above embodiments, the horizontal cross-sectional area of the tapered container or tapered shell can decrease linearly from the top to the bottom. Or the horizontal cross-sectional area can decrease monotonically, but non-linearly, from the top to the bottom.

In any of the above embodiments, the seed planting device can further comprise a porous or perforated lid fixed within or to the tapered container or tapered shell above the one or more seeds, seedlings, and/or saplings.

In any of the above embodiments, the seed planting device can further comprise a reservoir of water. In some of these embodiments, the reservoir of water is bounded at least in part by one or more frangible barriers configured to rupture upon deployment of the seed planting device into the forest floor.

In any of the above embodiments, the seed planting device can further comprise a weighted and/or pointed tip. In some of these embodiments, the weighted and/or pointed tip is configured to be separated from the tapered container or tapered shell by roots growing downward from vegetation arising from the one or more seeds, seedlings, and/or saplings, thereby creating an opening in the bottom of the tapered container or tapered shell.

And in any of the above embodiments, the tapered container or tapered shell can be biodegradable.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a cross-sectional view illustrating a prior art method of introducing vegetation into a forest floor after a forest fire, wherein a layer of ash is above a hydrophobic layer, which is above underlying soil;

FIG. 2A is a perspective view of a conical seed planting device according to an embodiment of the present invention;

FIG. 2B is a cross-sectional view of a square seed planting device having a water reservoir according to an embodiment of the present invention;

FIG. 2C is a perspective view of a star-shaped seed planting device according to an embodiment of the present invention;

FIG. 2D is a perspective view of a seed planting device similar to FIG. 2C, but having a monotonic but non-linear taper according to an embodiment of the present invention;

FIG. 3 is a perspective view of a drone deploying seed planting devices in a reforestation region at a minimum required average separation while avoiding obstacles such as tree stumps and rocks;

FIG. 4A is a cross-sectional view illustrating the seed planting devices of FIG. 2A penetrating through a hydrophobic layer of a forest floor;

FIG. 4B is a cross-sectional view illustrating growth of new trees from seed planting devices of FIG. 4A after deployment;

FIG. 5A is a perspective view of a seed planting device comprising a weighted and/or pointed tip;

FIG. 5B is a perspective view of the seed planting device of FIG. 5A after root growth has separated the weighted and/or pointed tip from the tapered container or tapered shell; and

FIG. 6 is a flow diagram illustrating a method embodiment of the present invention.

### DETAILED DESCRIPTION

The present invention is a method of establishing replacement trees in a reforestation region such that the replacement trees will grow and thrive during the entirety of a sustainability period without undue crowding, and without exceeding an available water supply in the reforestation region.

According to the present invention, a minimum average separation of replacement trees in the reforestation region is determined according to the desired sustainability period, an available water supply, and an anticipated water requirement of each replacement tree at the end of the sustainability period. Seed planting devices containing seeds, seedlings, or saplings of the selected species or variety are then deployed in the reforestation region in deployment locations having an average separation that is equal to or greater than the determined minimum average separation.

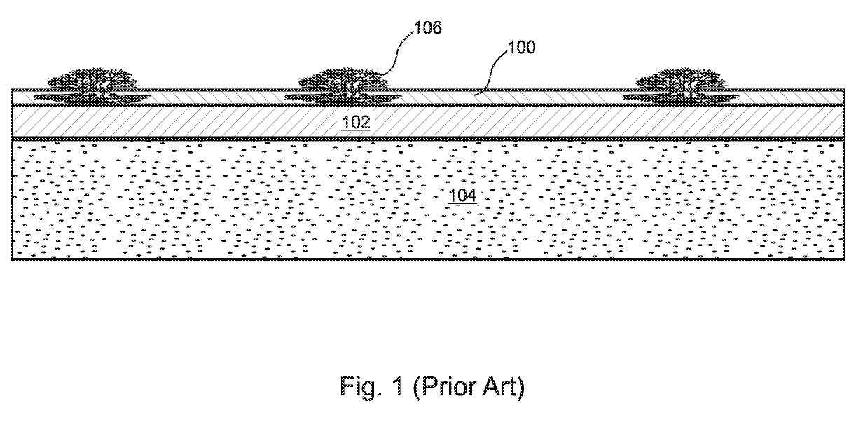

With reference again to FIG. 1, in some embodiments the reforestation region is a region that has experienced a forest fire. As described above, an intense forest fire can form a layer of ash 100 above a hydrophobic layer 102, which in turn is located above underlying soil 104. In such circumstances, newly introduced vegetation 106 may have difficulty extending roots through the hydrophobic layer 102 into the underlying soil 104. However, the present invention is not limited to reforestation after a forest fire, and can also be applied to regions that have been damaged by drought, disease, insect infestation, logging, blight, storm damage, or other causes.

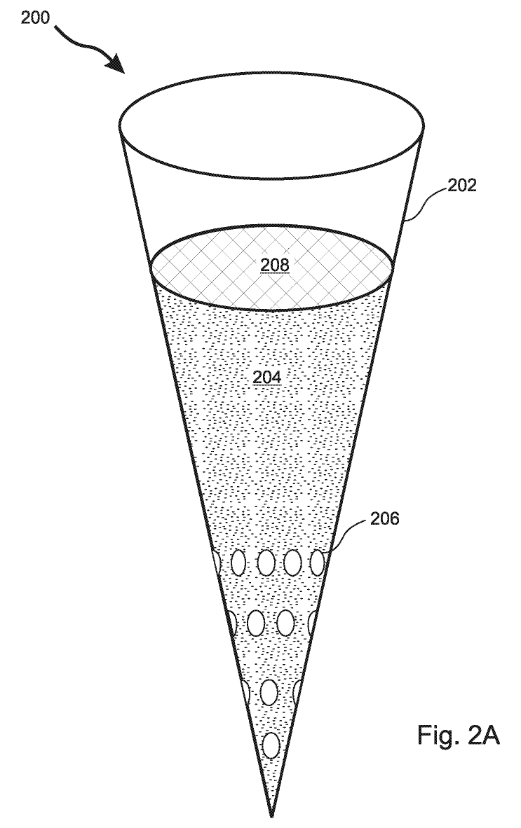

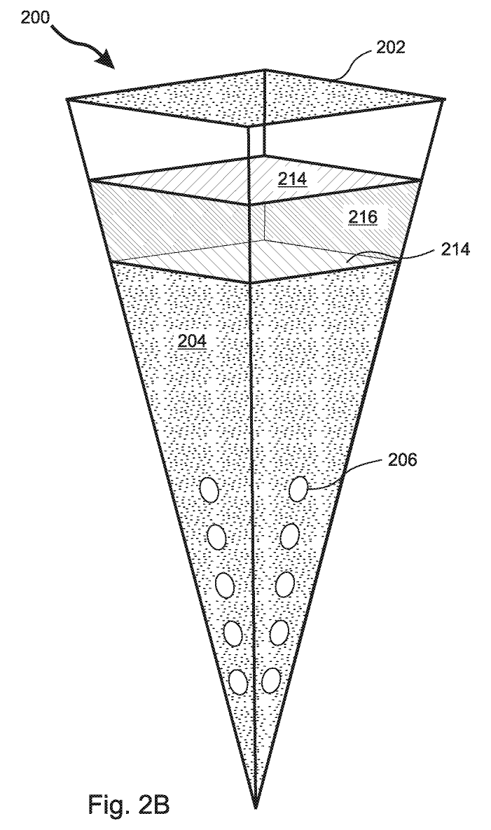

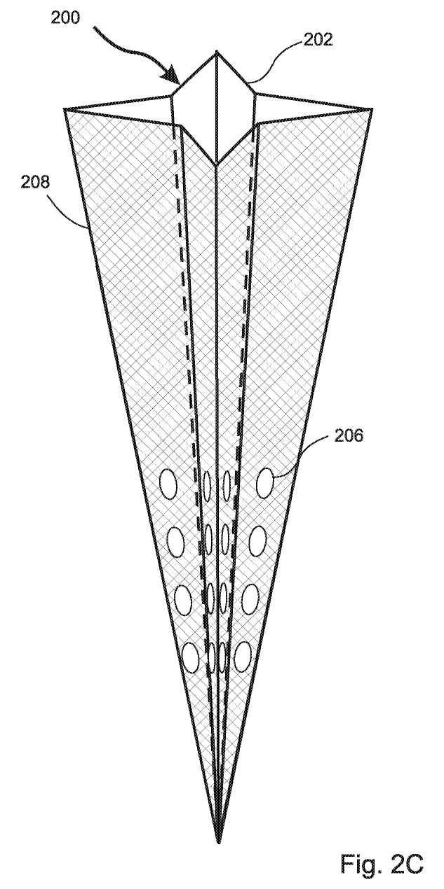

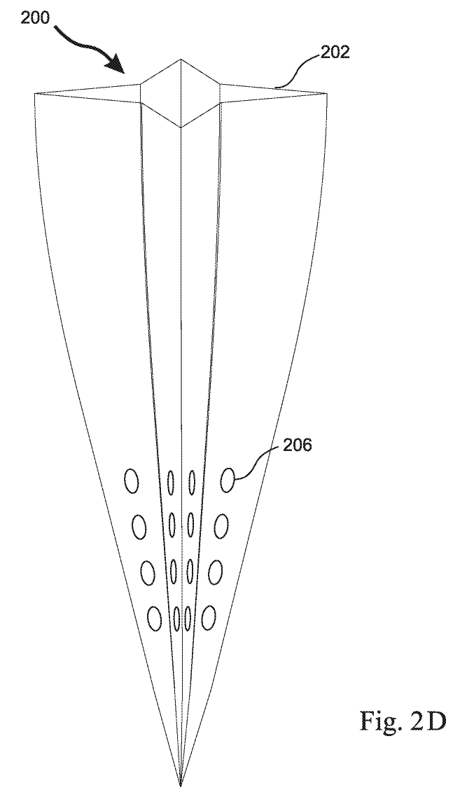

With reference to FIGS. 2A–2D, in embodiments each seed planting device 200 comprises a tapered container or tapered shell 202 that contains one or more seeds, seedlings, and/or saplings that are optionally mixed with sand and/or soil. The term “seed mixture” is used herein to refer to the seeds, seedlings, and/or saplings, either alone if no other ingredients are included, or in combination with any other materials that are mixed therewith. For example, the seed mixture 204 can include any combination of soil, sand, gravel, water, fertilizer, super-absorbent polymer granules, nutrients, and/or other materials that support germination or growth.

The tapered container or tapered shell 202 has a top, a bottom, and an outer tapered surface extending therebetween. The horizontal cross-sectional area of the tapered container or tapered shell 202 is larger proximate the top than proximate the bottom, so that the seed planting device 200 tapers monotonically toward the bottom, thereby enabling the seed planting device 200 to penetrate into a forest floor when dropped, released, propelled, or otherwise deployed with sufficient force.

The cross-sectional shape of the tapered container or tapered shell 202 is not limited to a circular shape, as shown in FIG. 2A. For example, FIGS. 2B–2D illustrate seed planting devices 200 having different cross-sectional shapes and/or internal configurations. In various embodiments, the tapered container or tapered shell 202 can be round (FIG. 2A), oval, square or polygonal (FIG. 2B), star shaped (FIG. 2C), or any other cross-sectional shape, symmetric or asymmetric, provided that it tapers monotonically toward the bottom. In embodiments, the cross-sectional shape of the tapered container or tapered shell 202 is constant along the vertical length thereof, while in other embodiments the cross-sectional shape varies along the vertical length thereof. In the embodiments of FIGS. 2A – 2C, a horizontal size of the outer tapered surface decreases linearly along the entire vertical length of the seed planting device 200, while in FIG. 2D the taper is monotonic, but not linear.

In embodiments, before the seed planting device 200 is deployed, no part of the seed planting device 200, including the one or more seeds, seedlings, and/or saplings contained therein, extends vertically or radially beyond the outer tapered surface of the tapered container or tapered shell 202. In embodiments, this configuration avoids protrusions that would interfere with aerial deployment and/or penetration of the seed planting device 200 into the forest floor.

In embodiments, at least one hole 206 is provided proximate the bottom of the tapered container or tapered shell 202. In embodiments, the at least one hole 206 penetrates the outer tapered surface proximate the bottom. The hole or holes 206 are configured to allow water to seep through the tapered container or tapered shell 202 and to allow roots to emerge from the seed planting device 200, while being small enough to prevent significant loss of the seeds, seedlings, saplings, and/or seed mixture 204 before deployment.

In embodiments, a porous or perforated lid 208 is fixed within or to the tapered container or tapered shell 202 above the seed mixture 204. The lid 208 can be configured to prevent significant ejection of the seed mixture 204 during dropping, propelling, impact, or other deployment of the seed planting device 200, while allowing water to enter the tapered container or tapered shell 202. In embodiments, the lid 208 is frangible, biodegradable, or provided with openings large enough to allow vegetation to grow through the lid 208.

With reference to FIG. 2B, in embodiments the seed planting device 200 includes a reservoir of water 216. In the illustrated embodiment, the water 216 is contained between frangible, water-impermeable barriers 214 located above the seed mixture 204. The barriers 214 are configured to retain the water 216 before deployment and to rupture, break, or otherwise open upon impact of the seed planting device 200 with the forest floor, thereby allowing the water 216 to flow into the seed mixture 204. In embodiments, the added water also increases the weight of the seed planting device 200, thereby improving penetration into the forest floor.

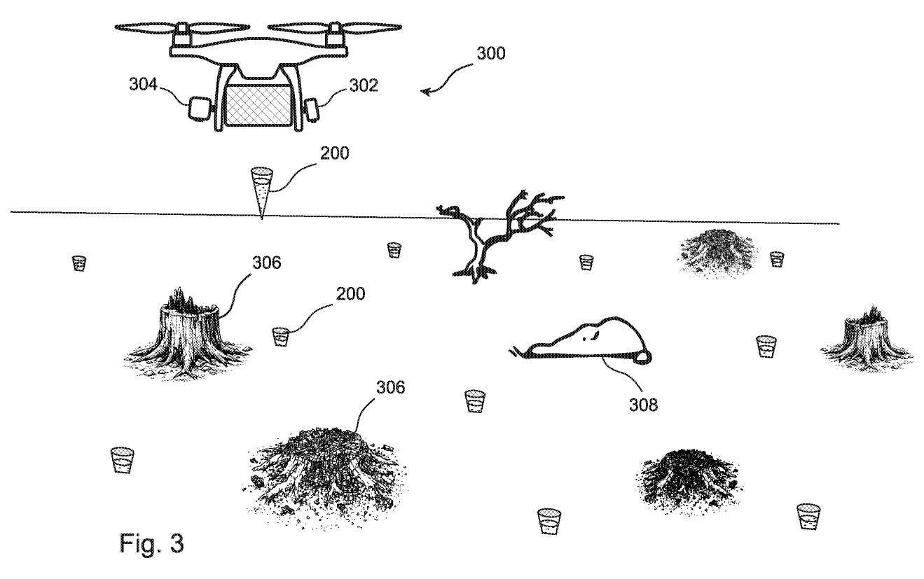

With reference to FIG. 3, after the minimum required average separation has been determined, one or more drones 300 deploy a plurality of seed planting devices 200 into a reforestation region at deployment locations having a separation that is equal to or greater than the determined minimum required average separation. In embodiments, the drones are able to select deployment locations that avoid obstacles such as tree stumps 306 and rocks 308 that would impede or prevent healthy growth of a new tree.

In embodiments, the drone 300 includes a release mechanism configured to release the seed planting devices 200 at selected deployment locations. In embodiments, the drone 300 also includes a controller configured to cause the drone 300 to navigate to the deployment locations and to cause the release mechanism to release the seed planting devices 200. The drone 300 can release the seed planting devices 200 by dropping them under the force of gravity, by propelling them toward the forest floor, or by otherwise depositing them onto or into the forest floor.

In embodiments, the drone 300 uses GPS navigation, inertial navigation, optical navigation, terrain mapping, wind speed data, wind direction data, altitude data, release timing, and/or other navigation or compensation data to place the seed planting devices 200 at the deployment locations.

In embodiments, the seed planting devices 200 need not be deployed in a strict geometric array. Instead, it is only necessary that the seed planting devices 200 are deployed such that their average separation is at least as large as the minimum average separation. This allows individual seed planting devices 200 to be shifted locally to avoid tree stumps 306, rocks 308, fallen trees, bodies of water, or other surface features, while still providing an average separation that is consistent with the available water supply and the water requirement of the selected tree species or variety.

The drone 300 can include one or more surface sensors 302, 304 that assist in selecting the deployment locations. The surface sensors 302, 304 can include, for example, any combination of visible-light cameras, infrared cameras, thermal cameras, LIDAR sensors, stereo-vision sensors, structured-light sensors, radar range sensors, ultrasonic range sensors, multispectral cameras, hyperspectral cameras, and/or other sensors configured to detect surface features of the reforestation region.

In embodiments, the drone 300 uses surface-sensing data from the sensors 302, 304 to select deployment locations that avoid tree stumps 306, rocks 308, fallen trees, standing dead trees, bodies of water, steep terrain features, debris, or other obstacles or unsuitable surface locations. For example, if a deployment location determined according to the desired average separation corresponds to a tree stump 306, rock 308, or other obstacle, the drone 300 can shift the deployment location to a nearby location that is more suitable for receiving the seed planting device 200.

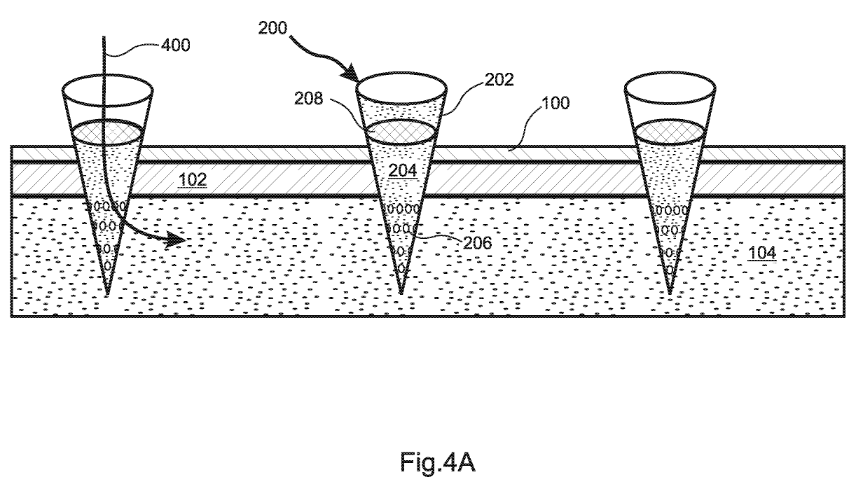

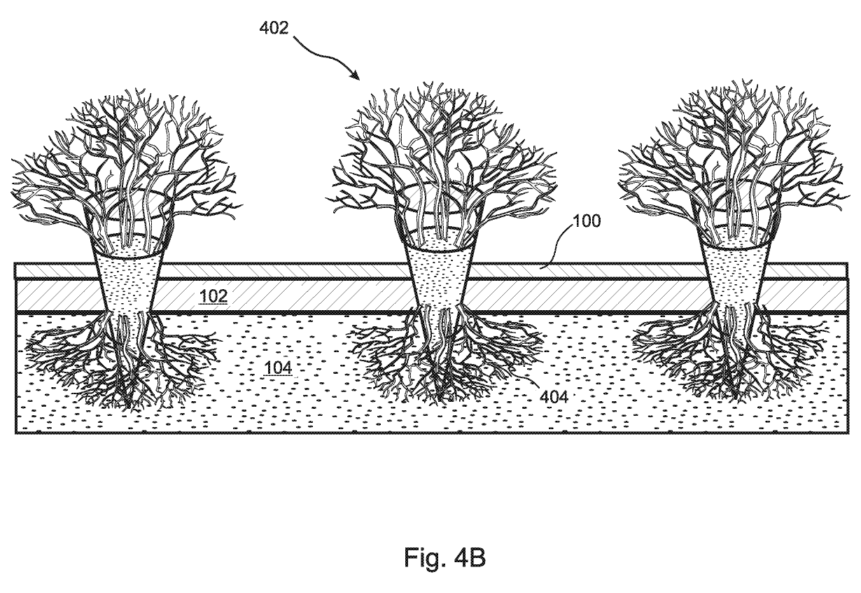

With reference to FIG. 4A, upon deployment the seed planting devices 200 penetrate into the forest floor. In some embodiments where a region is being reforested after a forest fire, the forest floor includes ash 100, a hydrophobic layer 102, and underlying soil 104. In such embodiments, the seed planting devices 200 penetrate through the hydrophobic layer 102, thereby forming pathways through which water can pass, as indicated by arrows 400, and through which roots can grow into the underlying soil 104. However, the seed planting devices 200 can also be used to reforest regions where no hydrophobic layer 102 is present.

With reference to FIG. 4B, after deployment, the seeds, seedlings, and/or saplings contained within the seed planting devices 200 germinate and/or grow into new trees 402. Roots 404 of the new trees 402 can extend through the holes 206 of the tapered containers or tapered shells 202 and into the surrounding soil 104. In embodiments where a hydrophobic layer 102 is present, the roots 404 can extend below the hydrophobic layer 102, thereby anchoring the new trees 402 more securely and enabling the new trees 402 to access water in the underlying soil 104.

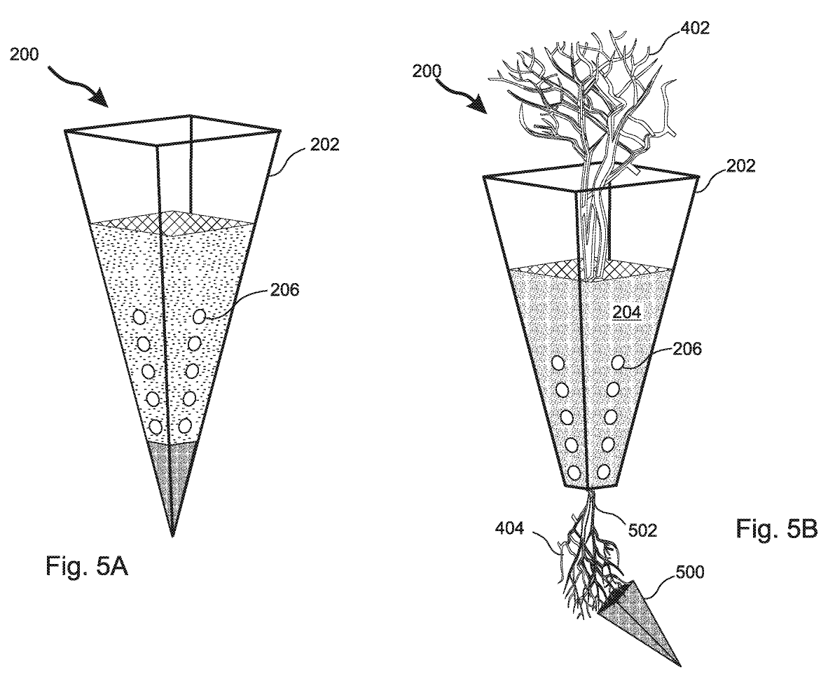

With reference to FIGS. 5A and 5B, in embodiments the seed planting device 200 includes a weighted and/or pointed tip 500. The weighted and/or pointed tip 500 provides additional weight, energy, and/or penetrating power to the seed planting device 200, thereby assisting the seed planting device 200 in penetrating into the forest floor, and through a hydrophobic layer 102 if present, when dropped or propelled from a drone 300 or otherwise deployed.

With reference to FIG. 5B, in embodiments the weighted and/or pointed tip 500 is configured to be separated from the tapered container or tapered shell 202 after the seed planting device 200 is deployed. For example, roots 404 growing downward from new vegetation 402 can push the weighted and/or pointed tip 500 away from the tapered container or tapered shell 202, thereby creating an opening 502 in the bottom of the seed planting device 200. The opening 502 can allow additional roots 404 and water to pass through the bottom of the seed planting device 200.

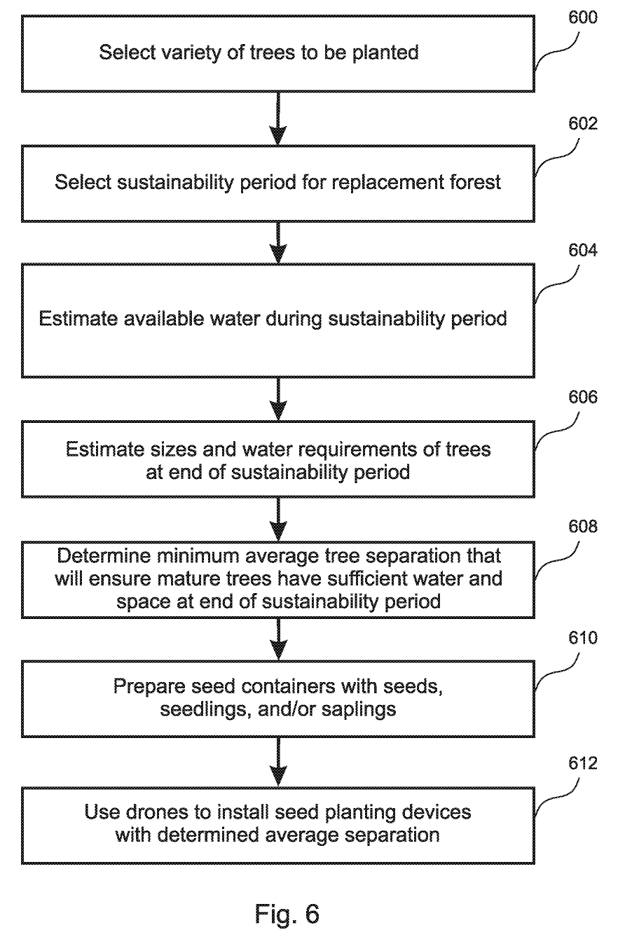

With reference to FIG. 6, in an exemplary method embodiment, a species or variety of trees to be planted is selected 600, as well as a sustainability period for the replacement forest 602. Selecting the tree species or variety 600 can include performing a genetic analysis of tree species and/or varieties and considering the estimated water requirements, growth rates, and resistance to climate change of each species or variety. The sustainability period is selected 602 as a duration of time during which it is desirable for the replacement trees to remain healthy without undue crowding and without exceeding the available water supply. For example, the sustainability period can be 100 years, or even 300 years or more.

Available water during the sustainability period is estimated or otherwise determined 604 according to one or more water availability parameters including, for example, water table depth, aquifer capacity, expected rainfall, historical rainfall, expected drought frequency, soil type, soil water retention, slope, runoff, drainage, watershed characteristics, irrigation availability, and/or other sources or limitations of water available to the replacement trees.

The sizes and water requirements of the trees at the end of the sustainability period are estimated 606 based on an assumption that the trees remain healthy and continue to grow throughout the sustainability period. The water requirement of the selected tree species or variety can be determined as a function of tree age, maturity, size, canopy spread, root development, season, climate, and/or expected growth rate.

A minimum average tree separation that will enable the trees to remain healthy at the end of the sustainability period without undue crowding and without exceeding the available water supply is then determined 608. Seed containers are prepared with seeds, seedlings, and/or saplings 610, and drones are used to install the seed planting devices with the determined average separation 612.

In embodiments, determining the average tree separation includes determining a maximum number of trees that can be supported per unit area over the desired sustainability period without undue crowding and without exceeding the available water supply as the trees grow and mature.

In embodiments, the seed planting devices 200, lids 208, tips 500, and/or other components thereof are made from one or more biodegradable materials, so that after the seed planting devices 200 have been deployed and the trees 402 have become established, the seed planting devices 200 biodegrade and blend into the soil. Suitable biodegradable materials can include, for example, AshCrete, hempcrete clay, coir, Timbercrete, bamboo, recycled wood, and/or other recycled or biodegradable materials.

In embodiments, any of the seed planting devices 200 described herein can be used together with any of the average separation, drone deployment, obstacle avoidance, and sustainability-period features described herein, unless such features are mutually incompatible. The features disclosed herein for the various embodiments can generally be interchanged and combined into any combinations that are not self-contradictory without departing from the scope of this disclosure.

The foregoing description of the embodiments of the invention has been presented for the purposes of illustration and description. Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure.

Although the present application is shown in a limited number of forms, the scope of the disclosure is not limited to just these forms, but is amenable to various changes and modifications. The present application does not explicitly recite all possible combinations of features that fall within the scope of the disclosure. The features disclosed herein for the various embodiments can generally be interchanged and combined into any combinations that are not self-contradictory without departing from the scope of the disclosure. In particular, the limitations presented in dependent claims below can be combined with their corresponding independent claims in any number and in any order without departing from the scope of this disclosure, unless the dependent claims are logically incompatible with each other.

What is claimed is:

1. A method of reforesting a reforestation region, the method comprising:
selecting a species or variety of replacement trees to be planted in the reforestation region;
selecting a sustainability period for a replacement forest to be established in the reforestation region;
estimating an available water supply for the reforestation region during the sustainability period;
determining a water requirement of replacement trees of the selected species or variety at an end of the sustainability period, based on an assumption that the replacement trees remain healthy and continue to grow throughout the sustainability period;
according to the available water supply, the water requirement, and the sustainability period, determining a minimum average separation of the replacement trees that will enable the replacement trees to remain healthy at the end of the sustainability period without undue crowding and without exceeding the available water supply;
providing a plurality of seed planting devices, each of the seed planting devices comprising:
a tapered container or tapered shell having a top, a bottom, and an outer tapered surface extending between the top and the bottom, wherein a horizontal cross-sectional area of the tapered container or tapered shell is larger proximate the top than proximate the bottom, and said horizontal cross-sectional area decreases monotonically from the top to the bottom;
at least one hole penetrating the outer tapered surface proximate the bottom; and
one or more seeds, seedlings, and/or saplings of the selected species or variety contained within the tapered container or tapered shell;
wherein, before the seed planting device is deployed, no part of the seed planting device, including the one or more seeds, seedlings, and/or saplings, extends vertically or radially beyond the outer tapered surface of the tapered container or tapered shell;
determining deployment locations in the reforestation region, wherein an average separation of the deployment locations is equal to or greater than the determined minimum average separation; and
deploying the seed planting devices at the deployment locations, such that the seed planting devices penetrate into a forest floor of the reforestation region and the seeds, seedlings, and/or saplings germinate and/or grow into replacement trees.

2. The method of claim 1, wherein deploying the seed planting devices comprises deploying the seed planting devices using one or more drones.

3. The method of claim 2, wherein the one or more drones deploy the seed planting devices by dropping, releasing, propelling, pressing, or otherwise depositing the seed planting devices onto or into the forest floor.

4. The method of claim 2, wherein:
the one or more drones comprise one or more surface sensors configured to detect surface features of the reforestation region; and
the one or more drones use surface-sensing data from the one or more surface sensors to avoid tree stumps, rocks, fallen trees, standing dead trees, bodies of water, steep terrain features, debris, and/or other obstacles or unsuitable surface locations.

5. The method of claim 4, wherein the one or more surface sensors comprise one or more visible-light cameras, infrared cameras, thermal cameras, LIDAR sensors, stereo-vision sensors, structured-light sensors, radar range sensors, ultrasonic range sensors, multispectral cameras, and/or hyperspectral cameras.

6. The method of claim 1, wherein selecting the species or variety of replacement trees to be planted in the reforestation region comprises performing a genetic analysis of tree species and/or varieties and considering water requirements, growth rates, and resistance to climate change of each considered species or variety.

7. The method of claim 1, wherein estimating the available water supply comprises determining at least one water availability parameter selected from the group consisting of water table depth, aquifer capacity, expected rainfall, historical rainfall, expected drought frequency, soil type, soil water retention, slope, runoff, drainage, watershed characteristics, and irrigation availability.

8. The method of claim 1, wherein determining the water requirement comprises determining a water requirement of the selected species or variety according to tree age, maturity, size, canopy spread, root development, season, climate, and/or expected growth rate.

9. The method of claim 1, wherein the sustainability period is at least 100 years.

10. The method of claim 1, wherein the reforestation region has been damaged by fire.

11. The method of claim 10, wherein the reforestation region includes a hydrophobic layer beneath a layer of ash, and wherein deploying the seed planting devices causes the seed planting devices to penetrate through the hydrophobic layer.

12. The method of claim 1, wherein a horizontal cross-sectional shape of the tapered container or tapered shell is round, oval, square, polygonal, or star-shaped.

13. The method of claim 1, wherein the horizontal cross-sectional area of the tapered container or tapered shell decreases linearly from the top to the bottom.

14. The method of claim 1, wherein the horizontal cross-sectional area decreases monotonically, but non-linearly, from the top to the bottom.

15. The method of claim 1, wherein the seed planting device further comprises a porous or perforated lid fixed within or to the tapered container or tapered shell above the one or more seeds, seedlings, and/or saplings.

16. The method of claim 1, wherein the seed planting device further comprises a reservoir of water.

17. The method of claim 16, wherein the reservoir of water is bounded at least in part by one or more frangible barriers configured to rupture upon deployment of the seed planting device into the forest floor.

18. The method of claim 1, wherein the seed planting device further comprises a weighted and/or pointed tip.

19. The method of claim 18, wherein the weighted and/or pointed tip is configured to be separated from the tapered container or tapered shell by roots growing downward from vegetation arising from the one or more seeds, seedlings, and/or saplings, thereby creating an opening in the bottom of the tapered container or tapered shell.

20. The method of claim 1, wherein the tapered container or tapered shell is biodegradable.
